(19) United States
(12) Patent Application Publication
(10) Pub. No.: US 2006/0046740 A1
(43) Pub. Date: Mar. 2, 2006

(54) Technique for providing location-based information concerning products and services through an information assistance service

(76) Inventor: Karen L. Johnson, Portland, OR (US)

Correspondence Address: ALEX L. YIP;KAYE SCHOLER LLP, 425 PARK AVENUE, NEW YORK, NY, 10022, US

(21) Appl. No.: 10/932,273

(22) Filed: Sep. 1, 2004

(51) Int. Cl. H04Q 7/20

(52) U.S. Cl. 455/456.1

(57) ABSTRACT

A user who is “roaming,” as determined, e.g., by his/her use of a mobile communication device, or by his/her obtaining travel directions, may be tracked and offered various goods and services, and advertising information depending on the circumstances that the user may encounter. In a first embodiment, when a user calls an information assistance service for travel directions, his/her progress along the planned route defined by the travel directions is tracked. The information assistance service monitors conditions along the planned route, and if an event is detected that may affect the user's progress along the route, the user is contacted, e.g., by telephone and notified thereof. The information assistance service additionally provides to the user in the same call advertisements, suggestions, and offers to order or reserve goods and services pertaining to the user's circumstances. In a second embodiment, the user's progress to a destination is tracked, which is determined as a result of use of a concierge service also provided by the information assistance service. For example, when the user reserves movie tickets for a particular showtime at a cinema through the concierge service, it is assumed that the user will arrive at the destination, i.e., the cinema, around the showtime.

### FIELD OF THE INVENTION

The invention relates to a communications system and method, and more particularly to a system and method for delivering advertisements and services to a user of an information assistance service.

### BACKGROUND OF THE INVENTION

A traveler is in constant need of information concerning weather, traffic, flight schedules, directions, local accommodation, entertainments, etc. to ensure a smooth trip. For example, a traveler who is driving may utilize a mobile phone to call an information assistance service for such information, in addition to traditional directory assistance. Because of use of a mobile phone, the traveler's location may be determined by well known mobile handset location techniques such as a wireless network triangulation technique, a global positioning system (GPS) technique, etc. In fact, a wireless telephone carrier utilizes one such technique to determine an emergency “911” caller's location, in accordance with the U.S. federal mandate of the “E911” initiative.

A driving traveler may also participate in a roadside assistance program, such as an OnStar® service provided by General Motors Co, which offers help during a trip. An OnStar® participant has a GPS receiver installed in his/her vehicle, and a wireless phone connection to an OnStar® service agent. For example, when the participant realizes that the vehicle is low on fuel, he/she initiates a wireless communication to an OnStar® service agent, containing the GPS information concerning the current location of the vehicle, and requests the agent to locate the closest gas station.

### SUMMARY OF THE INVENTION

The invention is premised upon a recognition that a user who is “roaming” (as determined, e.g., by his/her use of a mobile phone, or the travel directions being obtained by him/her) or is in otherwise unfamiliar territory, should be provided with additional services in an anticipatory manner to minimize unpleasant surprises, and to make the trip go as smoothly as possible. In accordance with the invention, an information assistance service may track a user's whereabouts, anticipate circumstances which the user may encounter, and proactively suggest and/or offer goods or services to the user according to the circumstances. For example, knowing the approximate location of the user and the route the user is on, the information assistance service may monitor conditions along the route, e.g., whether a bridge on the route is temporarily closed, whether the road ahead is congested, etc. The information assistance service not only informs the user of upcoming circumstances which may affect the user, but also suggests to the user activities that were not originally planned. In view of the circumstances, the information assistance service may offer to make a restaurant reservation for the user and provide advertising information concerning local restaurants to the user when it is close to mealtime. This is helpful especially when the user finds himself or herself in an area that he/she is not familiar with, and cannot efficiently obtain the desired services or products.

Thus, in accordance with the invention, after receiving a communication from the user, which includes a request for a service, an information assistance service determines that the user is traveling to a destination based on the requested service. In addition, it determines the location of the user each time when the user communicates with the information assistance service to track the user's progress to the destination. In response to a detection of an event affecting the user's progress to the destination, the information assistance service communicates, to the user, selected information to cope with a circumstance caused by the event.

### BRIEF DESCRIPTION OF THE DRAWINGS

Further objects, features and advantages of the invention will become apparent from the following detailed description taken in conjunction with the accompanying drawings showing an illustrative embodiment of the invention, in which:

FIG. 1 illustrates an example of a communications system including information/call centers;

FIG. 2 is a block diagram of an information/call center in accordance with the invention;

FIG. 3 is a block diagram of a directions server in the information/call center for obtaining travel directions from a remote map server;

FIG. 4 is a block diagram of an interactive voice response (IVR) unit for interacting with a user in accordance with the invention;

FIG. 5 is a flowchart depicting a routine for delivering certain direction terms using the IVR unit of FIG. 4;

FIG. 6 illustrates a request for travel directions sent by the directions server of FIG. 3;

FIG. 7 is a memory map of a copy of a directions file in the IVR unit of FIG. 4;

FIG. 8 tabulates different navigation commands and their corresponding functions;

FIG. 9 is a flowchart depicting a routine for reading directions from the directions file in accordance with the invention;

FIG. 10 is a block diagram showing components of a user locator for tracking the progress of users toward a destination;

FIG. 11 illustrates a user location folder maintained in the user locator of FIG. 10;

FIG. 12 illustrates a user route table maintained in the user locator of FIG. 10;

FIG. 13 illustrates an event message to the user locator of FIG. 10 to report an event in a first embodiment;

FIG. 14 is a flowchart depicting a routine for generating a list of users affected by an event;

FIG. 15 shows a list of users who may be affected by an event, including information related to the users;

FIG. 16 is a flowchart depicting a routine for generating criteria for advertisements and offers;

FIG. 17 illustrates a message for delivering advertisement criteria to a concierge server;

FIG. 18 illustrates a user profile record maintained by the system of FIG. 1;

FIG. 19 is a block diagram illustrating components of a concierge server;

FIG. 20 illustrates a concierge customer table for storing information about users of a concierge service;

FIG. 21 illustrates an event message to the user locator of FIG. 10 to report an event in a second embodiment;

FIG. 22 is a flowchart depicting a routine for determining if a user may be affected by an event;

FIG. 23 shows a list of users who may be affected by an event, including information related to the users; and

FIG. 24 is a flowchart depicting a routine for generating criteria for advertisements and offers.

### DETAILED DESCRIPTION

The invention is directed to providing an information assistance service to proactively assist a user along his/her way to a destination. The invention is premised upon a recognition that a user who is “roaming” (as determined, e.g., by his/her use of a mobile phone, or the travel directions being obtained by him/her) or is in otherwise unfamiliar territory, should be provided with additional services in an anticipatory manner to minimize unpleasant surprises, and to make the trip go as smoothly as possible. In accordance with the invention, an information assistance service may track a user's whereabouts, anticipate circumstances which the user may encounter, and proactively suggest and/or offer goods or services to the user according to the circumstances. For example, knowing the approximate location of the user and the route the user is on, the information assistance service may monitor conditions along the route, e.g., whether a bridge on the route is temporarily closed, whether the road ahead is congested, etc. The information assistance service not only informs the user of upcoming circumstances which may affect the user, but also suggests to the user activities that were not originally planned. To better serve the user, a provider of the information assistance service, e.g., an operator, is selected, who possesses local knowledge of the area in which the suggested activities will take place.

In a first illustrative embodiment of the invention, after a user requests travel directions, his/her progress along the route defined by the travel directions is monitored. The information assistance service also monitors conditions along the planned route, and if an event (e.g., bridge closing, congested traffic, etc.) is detected that may affect the user's progress along the route, the user is contacted and notified of the event, e.g., by phone. During one such call, the information assistance service may additionally deliver to the user one or more advertisements pertaining to goods or services available in the vicinity of a section of the route, and/or offer to order or reserve such goods or services for the user to cope with the circumstances caused by the event. For instance, the information assistance service may offer to make a restaurant reservation for the user, and provide advertising information concerning local restaurants to the user when it is close to mealtime. This is helpful especially when the user finds himself/herself in an area that he/she is not familiar with, and cannot efficiently obtain the desired goods or services.

In a second illustrative embodiment, an information assistance service also provides concierge services including, e.g., reserving a hotel room, rental car, a table at a restaurant, etc., and ordering event tickets, flower delivery, or other goods or services for a user. Upon receiving a user call for a concierge service, e.g., reserving movie tickets for an 8:00 pm movie at a particular cinema, the information assistance service determines that the user most likely will be at the cinema or in its vicinity at 8:00 pm. Knowing such destination and time of arrival, the user's location may be monitored in case an event is detected which may affect the user's travel to the cinema. The information assistance service may rely on a mobile handset location technique (e.g., GPS, wireless network triangulation, etc.) to learn the user's current location each time when the user contacts the information assistance service. It should be noted that the user may contact the information assistance service not only for travel directions and concierge services, but also other services including obtaining directory assistance, and weather, traffic, horoscope, flight schedule and other information; accessing the user's private calendars and directories maintained by the information assistance service; etc. If it is determined that an event may affect the user's travel to the cinema, the user is informed, e.g., by phone of the event and also advertisements or offers for selected goods or services relevant to the user's current circumstances. For example, if it is determined that the event would delay the user's arrival at the cinema for the scheduled movie, the information assistance service may offer to contact the cinema and change the tickets for a later showtime.

In the first embodiment of the invention, a user may contact the information assistance service for travel directions, e.g., driving directions, to a desired destination. The user may obtain the driving directions in installments using a communications device, e.g., a telephone, mobile phone, personal digital assistant (PDA), facsimile receiver, pager, short message service (SMS) device, etc. The technique of providing travel directions in installments through an information assistance service is fully described, e.g., in copending, commonly assigned U.S. application Ser. No. 09/826,122 filed on Apr. 4, 2001, whose disclosure is incorporated hereinbelow.

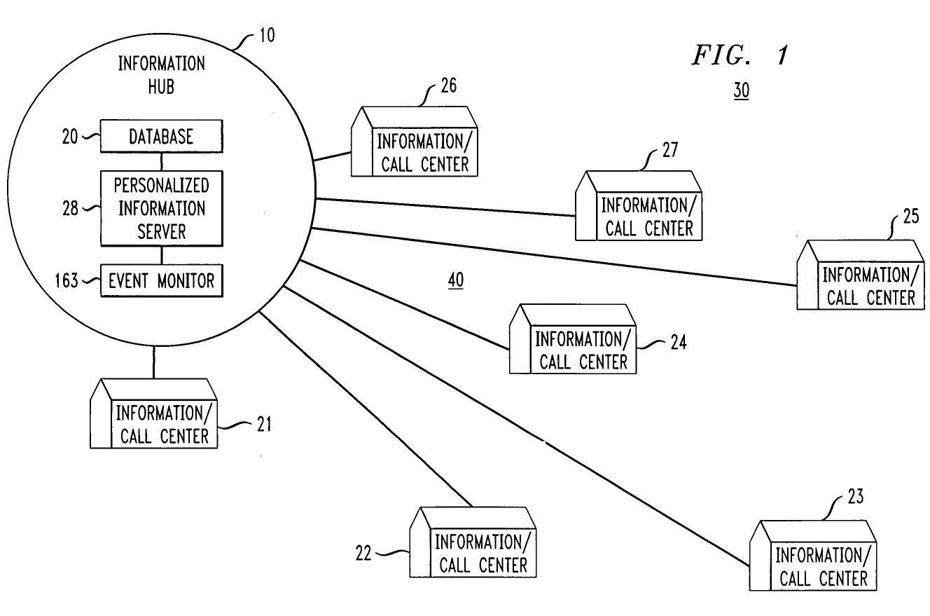

FIG. 1 illustrates an example of a communications system 30 including several information/call centers. In this example, the communications system 30 is an information assistance service system. System 30 includes a plurality of operators dispersed throughout a wide coverage area in information/call centers 21 through 27. Information/call centers 21 through 27 are coupled to each other and to one or more information hubs 10 through a network 40. The network may be a wide area network (WAN) 40 covering an extensive area, for example. WAN 40 can be an Internet-based network, such as the World Wide Web, or a private intranet based network. Each of information/call centers 21 through 27 may cover one or more regional coverage areas. System 30 may be accessed directly by a user on a wireline phone, wireless phone, and other such communications devices through which a customer may communicate with system 30 by voice.

Information hub 10 may include one or more processors, such as personalized information server 28, which is accessible by the operators in system 30, and one or more databases, such as database 20, in which, among others, identifying information about each user is stored and maintained. Each subscriber account may include one or more individual users. For example, a single account established by a subscriber (e.g., a parent) may include multiple members of a family as users (e.g., children). Similarly, a single account established by a business subscriber may include multiple employees of the business as users.

A subscriber folder may be associated with one or more communications identifications of the respective subscriber's communications devices that the subscriber has registered with system 30. For example, the communications identification may be a phone number of a subscriber's wireline or wireless phone. The presence or absence of a subscriber folder corresponding to a phone number or other such identifying data may be used to indicate whether a caller is an authorized user of the system or not.

The subscriber folder may include user profiles of the subscriber and other users of the subscriber account. Each user profile may contain preferences of the user associated therewith, as described in co-pending, commonly assigned application Ser. No. 10/323,287, filed on Dec. 19, 2002 (“the '287 application”), incorporated herein by reference. A user may specify in a user profile his/her preferred types of events, areas of interest, food, goods, services, manufacturers, merchants and other personal preferences, e.g., preferred music, fashion, sports, restaurants, seating on a plane, frequent flyer number, frequent stay number, sizes of jackets, etc. Such a profile may be used by a server to tailor the content of information delivered automatically to the user as soon as the information becomes available. The user may also specify in the profile the preferred method of handling his/her information assistance call, e.g., use of a special skilled operator, such as a Spanish speaking operator, to answer such a call. Thus, by using a user profile, the user is automatically provided with an individualized service, without the need of otherwise repeating the preferences each time when calling an operator to obtain information and assistance. The user profiles in the subscriber folder may contain a voiceprint sample of the users associated with the account, respectively. The voiceprint sample may be compared to a voiceprint received from a caller to verify the identity of the caller, enabling greater personalization of services based on the caller's user profile, as described further below.

The personal preferences in a user profile may be specified by a user during registration with system 30 via a phone call, for example, in response to registration questions posed by an operator or a voice response unit (VRU). Personal preferences may also be entered and changed via a web page. A subscriber will typically also register the phone number of each phone that may be used to call system 30, and identify the type of phone as a wireline or wireless phone. A phone that is used as a speakerphone may also be identified as such.

One or more voiceprints may be obtained during the registration process and subsequent calls between a user and system 30 to derive a voiceprint sample, in accordance with certain embodiments of the invention, as discussed further below. If there are multiple users to an account, each user may provide a voiceprint during registration by speaking on the phone in turn, or at a later date.

Subscriber folders and other such information may also be stored locally at one or more of the information/call centers 21 through 27, as described in the '287 application. Local storage may speed access to the information by a respective information/call center 21 through 27. The folders and information at different information/call centers may be synchronized. Synchronized databases provide necessary backup as well as support to roaming mobile device users.

While information assistance service system 30 in this example includes a plurality of information/call centers 21 through 27, the invention may be implemented in a system including a single information/call center coupled to an information hub.

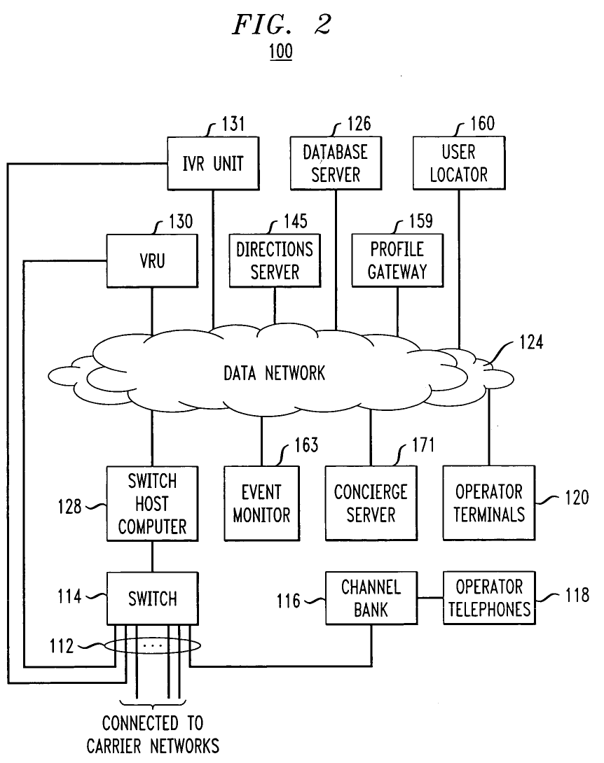

FIG. 2 illustrates an information/call center 100 embodying the principles of the invention. In this illustrative embodiment, a user utilizes a mobile phone to call an information assistance operator in center 100 to request directions to a desired destination. The term “operator” used herein broadly encompasses entities that are capable of providing information assistance in a communication environment, including without limitation human operators, voice response/recognition capabilities, web-enabled operator services, and other electronic access. The operator obtains the requested directions and causes them to be stored in a directions file. In this instance, such a file is identified by the user's telephone number (also known as a “mobile directory number (MDN)” for a mobile phone) or other identifier(s). To facilitate the user receiving directions in installments, a pointer associated with the directions file is used to keep track of the directions which have been retrieved from the file and sent to the user. The size of each installment of directions is controllable by the user. In providing the directions, the operator may connect the user to interactive voice response (IVR) unit 131 described below. IVR unit 131 reads to the user the directions from the file in an automated voice until the user signals to end the current installment, e.g., by disconnecting the call, or until the end of the directions file is reached, whichever occurs earlier. Other signals which may be used by the user to indicate the end of the current installment includes, e.g., a designated code or tones occasioned by pressing one or more keys on a key pad. After the current installment is delivered to the user, the pointer advances to indicate the location in the directions file from which the next installment is to begin. Thus, for example, after the traveling user consumes the directions in the current installment, the user may call back for the next installment whenever he/she is ready. After the user in the call-back indicates his/her intent to retrieve additional directions for the previously planned route, IVR unit 131 accesses the previously created directions file. IVR unit 131 then continues to deliver the remaining directions from a file location indicated by the pointer until, again, the user signals to end the current installment or until the end of the directions file is reached, whichever occurs earlier. The user may repeat the above process to retrieve additional installments of directions for the same route. Moreover, by relying on the pointer to indicate the file location from which the directions are retrieved, IVR unit 131 is capable of providing such cassette tape player functions as fast forwarding, rewinding, etc. in delivering the directions, thereby enabling the user to further control the direction delivery.

As shown in FIG. 2, information/call center 100 includes switch 114 having T1 spans 112 for connection to voice response unit (VRU) 130, channel bank 116 and carrier networks. Channel bank 116 is used to couple multiple operator telephones 118 to switch 114. The operators in call center 100 are further equipped with operator terminals 120, each of which includes a video display unit and a keyboard with associated dialing pad. Operator terminals 120 are connected over data network 124 to database server 126. Switch host computer 128, VRU 130, IVR unit 131, user locator 160, event monitor 163, concierge server 171 and directions server 145 are also connected to data network 124. By way of example, data network 124 includes a local area network (LAN) supplemented by a number of point-to-point data links.

Information/call center 100 also includes profile gateway 159 coupled to data network 124. Profile gateway 159 communicates with information hub 10 to request user preferences, as recorded in a user profile. Center 100 may receive an incoming information assistance call from one of the carrier networks through a carrier switching center therein. It also places outgoing calls through one of the carrier networks which may be different than that used for the incoming call.

Switch 114 is conventional which includes digital signal processing circuitry providing the requisite conference capability, and DTMF and multi frequency (MF) tone generation/detection capabilities. In this illustrative embodiment, switch 114 supports digital T1 connectivity. The operation of switch 114 is governed by instructions stored in switch host computer 128.

Each incoming information assistance call from a user is received by switch 114 in center 100 which connects it to an available operator's telephone. If no operator is available when a call is received, the call is queued in a conventional manner until an operator becomes available. The queuing and call distribution in this instance is in accordance with a standard Automatic Call Distribution (ACD) algorithm. Operators may utilize database server 126 to provide information assistance including searching for a user's desired party and determining the appropriate destination number of the party.

VRU 130 is used to play the constant repeated parts of an operator's speech, namely, the various greetings and signoffs (or closings). VRU 130 is connected via data network 124 to switch host computer 128 and via one or more T1 spans to switch 114. At appropriate stages in a call progression, switch host computer 128 initiates a voice path connection between VRU 130 and switch 114 such that the user, or the user and the operator, are able to hear whatever pre-recorded speech is played on that connection by VRU 130. Computer 128 then instructs VRU 130, via data network 124, what type of message to play, and passes data parameters that enable VRU 130 to locate the message appropriate to the call state.

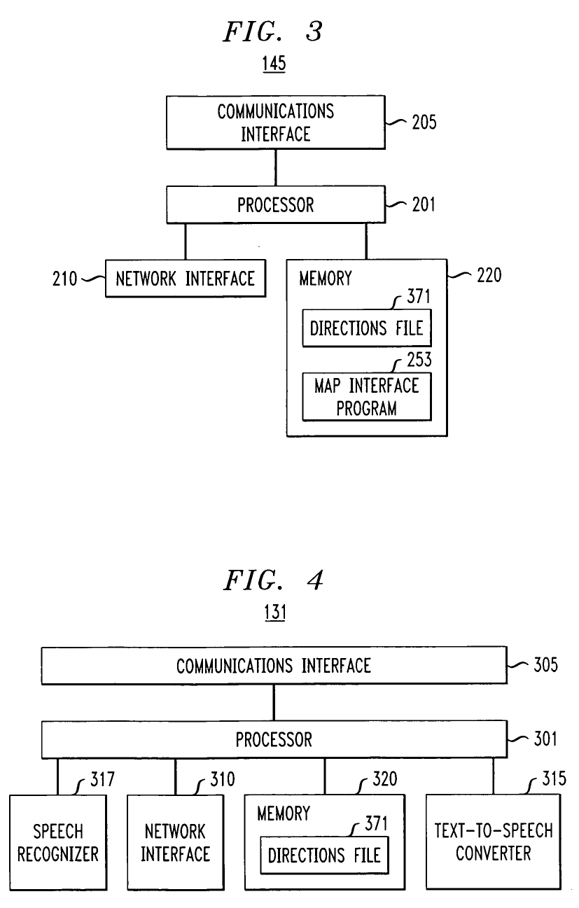

FIG. 3 illustrates directions server 145, which is connected to data network 124 through network interface 210. A daemon process, part of map interface program 253, runs on directions server 145. As is conventional, the daemon process is an agent program which continuously operates on server 145 as a background process and performs system-wide functions. In this instance, these functions include communicating with a remote map server at a predetermined uniform resource locator (URL) through communications interface 205. This map server is capable of providing maps and directions from a given origination point to a given destination point. For example, instructed by the daemon process, processor 201 elicits from an operator information, e.g., on the origination and destination addresses provided by the user for which the directions are sought. Processor 201 then arranges the provided information in an appropriate format for transmission to the map server via the Internet (or a dedicated network link). After learning the origination and destination addresses, the map server returns a directions file providing, among others, directions from the origination address to the destination address. Such a directions file, denoted 371, is stored in memory 220.

In an alternative embodiment, all necessary functionality and data by the remote map server are incorporated into directions server 145, thereby obviating the need of remote access to such functionality and data.

FIG. 4 illustrates IVR unit 131 which, as mentioned before, is used to interact with the user and read to the user the directions from a directions file, e.g., directions file 371. As such, a copy of file 371 is provided to unit 131 and temporarily stored in memory 320. IVR unit 131 also includes text-to-speech converter 315 for converting textual directions in directions file 371 to the corresponding synthesized voice version. To that end, converter 315 parses file 371 and strips it of non-textual, non-directional or other irrelevant information therein such as graphics and advertisement information also provided by the map server. In addition, converter 315 preprocesses file 371 to remove from the textual directions punctuation and special characters which serve no phonetic purposes.

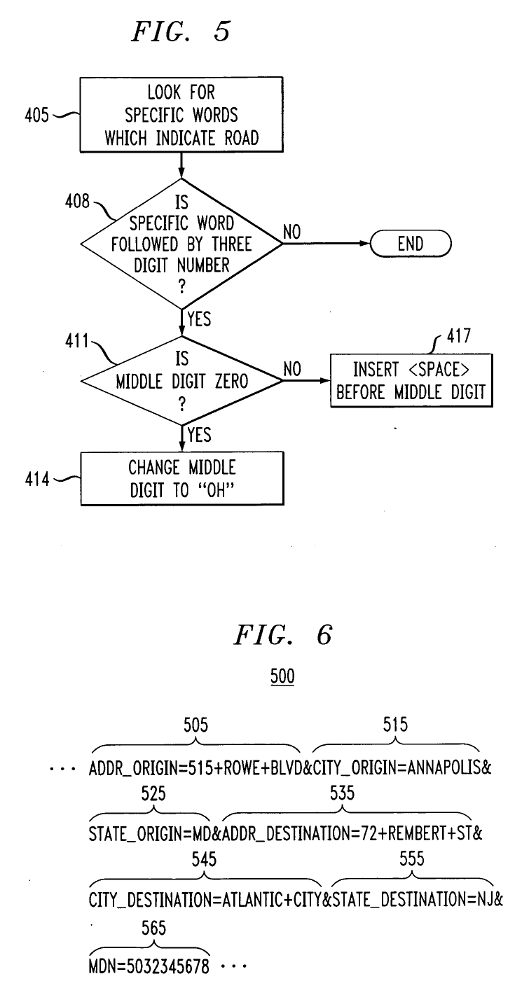

It should be noted that a conventional text-to-speech converter is not particularly feasible for delivering the directions here because of the peculiar language usage and local speech in verbalizing certain direction terms. Converter 315 is modified from one such conventional converter by incorporating thereinto context rules to adapt its output to common usage and local speech. In accordance with such rules, converter 315 looks for and replaces in directions file 371 selected direction terms, although textually correct in grammar and spelling, with words which are more “phonetically understandable,” resulting in a speech more readily understood by the human ear. For example, in the United States when given a three digit highway number where the 10's digit is a zero, e.g., Highway 205, one typically pronounces the highway number as “two oh five,” rather than “two hundred and five” as a conventional text-to-speech converter would pronounce without regard for the fact that it is a highway number. In addition, where the 10's digit of a three digit highway number is not a zero, e.g., Highway 217, one typically pronounces the highway number as “two seventeen,” rather than “two hundred and seventeen” as a conventional converter would pronounce. Thus, converter 315 also preprocesses the text from directions file 317 to, among others, look for specific words which indicate a road and which are normally followed and identified by a number such as “highway,” “freeway,” “parkway,” “route,” and their abbreviations “hwy,” “pkwy,” “rte,” etc., as indicated at step 405 in FIG. 5. At step 408, converter 315 determines whether one such specific word is followed by a three digit number. If not, the subject routine comes to an end. Otherwise, converter 315 at step 411 determines whether the middle digit is a zero. If so, converter 315 changes the middle digit to the word “oh,” as indicated at step 414. Otherwise, converter 315 inserts a <space> before the middle digit to separate the hundred's digit from the ten's and unit digits, as indicated at step 417.

In addition, converter 315 also screens for certain word patterns from directions file 317 and modify them to make them more phonetically understandable. For example, the word pattern “2a” as in route 2a, exit 2a and apartment 2a is replaced by “2 <space> eh,” and the word “Oregon” is replaced by “Oregun.” In addition, the abbreviations such as “hwy,” “pkwy,” and “rte” are replaced by their non-abbreviated versions such as “highway,” “parkway” and “route,” respectively. These word patterns, together with their replacements, are stored in a look-up table in converter 315. Such a table is developed through experience, usage and local knowledge, and thus may vary from one information/call center to another depending on the actual local region served thereby.

The user may interact with IVR unit 131 by communicating certain commands thereto, e.g., by pressing selected keys on the keypad. In addition, with speech recognizer 317, IVR unit 131 in this instance is receptive to the user commands via voice. Recognizer 317 affords continuous voice recognition with an optional cut-through feature so that a user can utter a command while the directions are being read by IVR unit 131. IVR unit 131 would then recognize the command, interrupt the text being read, and perform the appropriate function according to the command. In case of a noisy environment, the cut-through feature may be disabled to avoid false detection of a command.

By way of example, let's say a particular user named Mary while driving uses a mobile phone to call an information assistance provider, e.g., an operator, requesting the phone number and address of, and directions to, a desired destination, e.g., the Green Gables Motel in Atlantic City, N.J. In this example, the call is routed to information/call center 100 where an operator at an operator terminal 120 performs the requested search. Utilizing database server 126, the operator locates the motel at 72 Rembert Street, Atlantic City, N.J., and the phone number thereof. The motel's phone number and address are displayed on terminal 120 and then provided to Mary in a conventional manner. In this instance, the operator also invokes the aforementioned daemon process in directions server 145, which prompts for an origination and a destination for which the directions are sought. In response, the operator inputs the motel address at the destination prompt by transferring the already displayed motel address to the prompt, thereby obviating the need of transcribing it. Mary also communicates to the operator that she is currently located at 515 Rowe Boulevard, Annapolis, Md. Accordingly, the operator inputs the received address at the origination prompt.

Once the origination and destination addresses are entered, processor 201 formulates a directions request and transmits same to the aforementioned map server over the Internet. FIG. 6 illustrates one such request (denoted 500) that may be transmitted in connection with Mary's request for directions. In this example, the origination data is populated among ADDR_ORIGIN field 505, CITY_ORIGIN field 515, and STATE_ORIGIN field 525; and the destination data is populated among ADDR_DESTINATION field 535, CITY_DESTINATION field 545, and STATE_DESTINATION field 555. In addition, MDN field 565 contains the Mary's MDN which may be used to identify the directions file returned by the map server.

Request 500 is then communicated to the map server over the Internet through communications interface 205. In response to request 500, the map server devises a route connecting the origination address to the destination address, and the directions for realizing that route. The map server then formats the directions in a file and transmits the resulting directions file, in this instance file 371, to directions server 145, along with Mary's MDN. Instructed by map interface program 253, processor 201 assigns to file 371 a filename which may take the form nnnnnnnnnnn.<route_id>, where nnnnnnnnnn represents the digits of the user's MDN, and <route_id> represents a file extension for further identifying the requested route in case the same mobile phone user requests more than one route. Processor 201 causes file 371 to be opened on terminal 120, enabling the operator to view the directions for the requested route, along with the assigned name of file 371. The operator may briefly check the directions to see whether they correspond to the given origination and destination addresses. After the addresses are verified, the operator provides the telephone number for accessing IVR unit 131 and <route_id > file extension of file 371 to Mary for her later retrieval of directions directly from IVR unit 131. A copy of file 371 is thereafter transmitted to IVR unit 131. A copy of file 371 is provided to user locator 160 described below. Processor 301 in unit 131 processes the received file, places it in memory 320, and operates text-to-speech converter 315 to process file 371 in the manner described before and read from file 371 the requested directions and information, in an automated voice, to Mary over the established phone connection. However, it should be noted that instead of having IVR unit 131 deliver such directions and information, a user can always call and request an operator to communicate same to him/her verbally.

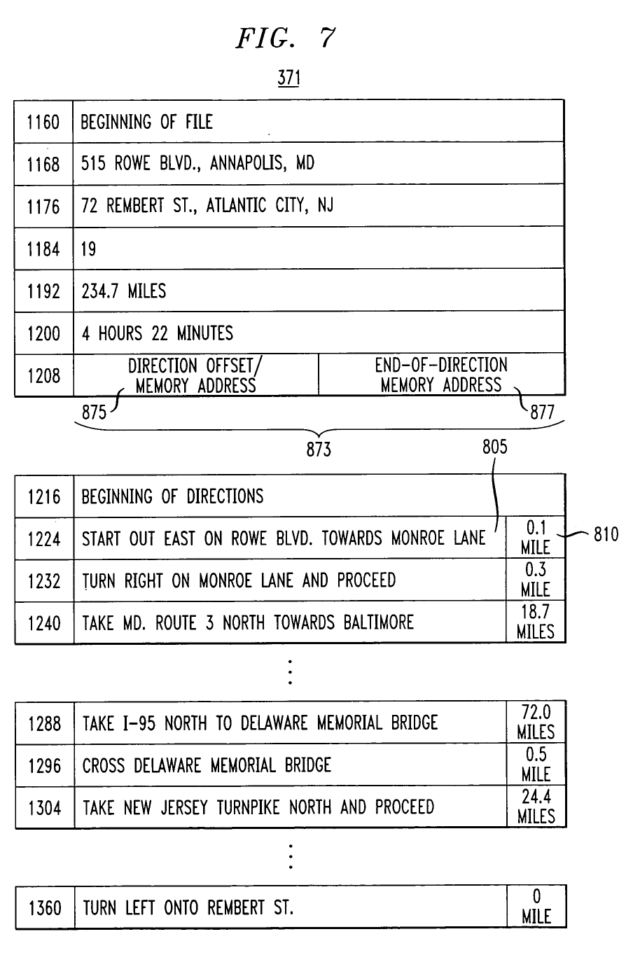

FIG. 7 illustrates a memory map of directions file 371 in memory 320. As shown in FIG. 7, file 371 starts with a “Beginning of File” indicator which in this instance is stored at memory address 1160. It should noted that the term “memory address” here refers to an address where an item is located in memory 320. On the other hand, an “offset address” refers to an address internal to file 371. For example, in this instance, the first item in file 371 consisting of the Beginning of File indicator has an offset address 0000 with respect to file 371, which however corresponds to the memory address 1160 with respect to memory 320. Thus, in this example, the difference between the offset address and the corresponding memory address is 1160. This being so, by knowing one of the offset address and memory address of an item, the other address can be readily determined based on their difference.

The Beginning of File indicator may include the name of file 371, e.g., “5032345678.A1” in this instance where “5032345678” is the Mary's telephone number (her MDN in this instance), and “A1” is the assigned <route_id> file extension. This filename, and the memory address of the Beginning of File indicator, i.e., 1160, are stored by processor 301 in a look-up table which associates the filename with the memory address.

Continuing the above example, data concerning the origination point of the subject route, i.e., 515 Rowe Blvd., Annapolis, Md., is stored at memory address 1168 (or offset address 0008). Data concerning the destination point of the subject route, i.e., 72 Rembert St., Atlantic City, N.J., is stored at memory address 1176 (or offset address 0016). Data concerning the total number of directions for the subject route, e.g., 19 in this instance, is stored at memory address 1184 (or offset address 0024). Data concerning the total distance of the subject route, e.g., 234.7 miles in this instance, is stored at memory address 1192 (or offset address 0032). Data concerning the estimated driving time, e.g., 4 hours, 22 minutes in this instance, is stored at memory address 1200 (or offset address 0040). Pointer 873 to be described is located at memory address 1208 (or offset address 0048). It should be noted that the offset addresses allocated for the origination point, destination point, number of directions, total distance of the route, estimated driving time and pointer 873 in a directions file are predetermined, thereby allowing processor 301 to readily locate and retrieve such data.

In addition, a “Beginning of Directions” indicator is stored at memory address 1216, followed by addressable directions. For example, at memory address 1224, the first direction includes directive 805, and mileage information 810 which pertains to directive 805. Thus, as processor 301 parses the directive 805 and mileage information 810 at memory address 1224, it causes text-to-speech converter 315 to read in an automated voice the first direction, e.g., “Start out going east on Rowe Boulevard towards Monroe Lane for 0.1 mile.” Similarly, the directive and mileage information comprising the second direction is stored at memory address 1232; the directive and mileage information comprising the third direction is stored at memory address 1240; and so on. The directive and mileage information comprising the final direction is stored at memory address 1360.

Pointer 873 includes direction offset/memory address field 875 and end-of-directions memory address field 877. Field 875 is used to store the offset address of the direction that was last read to the user. Thus, in computer programming parlance, pointer 873 is said to “point” at the last read direction in file 371. The offset address in field 875 is initially set to “0000.” Field 877 is used to store the memory address of the final direction. After file 371 is placed in memory 320, processor 301 locates the Beginning of Directions indicator and the final direction therein, and identifies their respective memory addresses, i.e., 1216 and 1360 in this instance. The Processor 301 then adds the memory address of the Beginning of Directions indicator, i.e., 1216, to the offset address in field 875 to obtain the memory address of the last read direction. This memory address is temporarily stored in field 875. Processor 301 also stores the memory address of the final direction, i.e., 1360, in field 877. While text-to-speech converter 315 is reading the directions to the user, the value of field 875 changes continually to keep track of the memory address of the last read direction. Changes to field 875 are also reported to user locator 160 to enable user locator 160 to keep track of users' progresses along their planned routes.

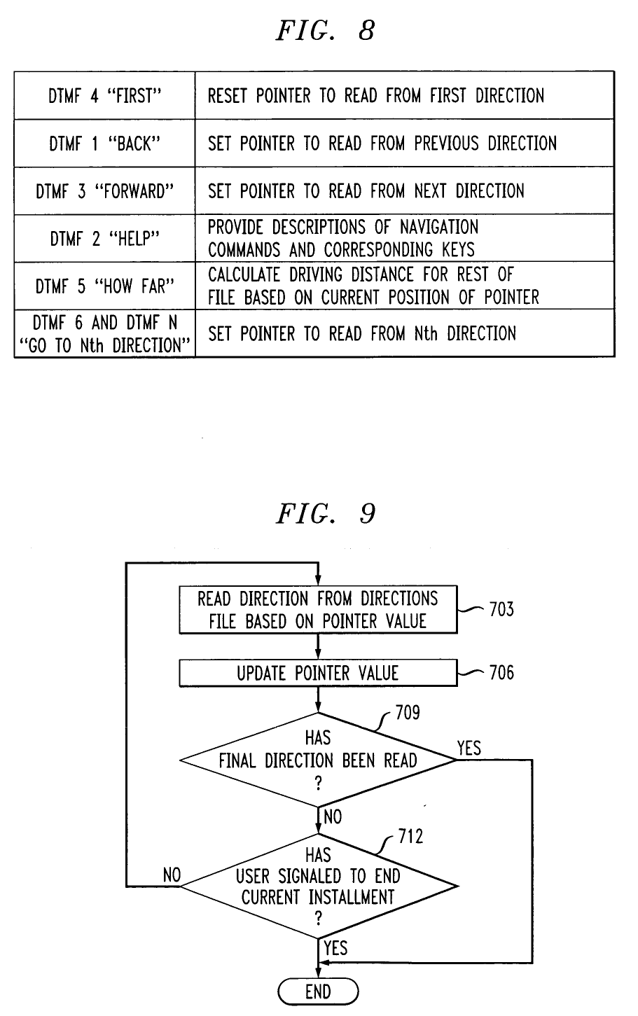

As the directions are being read to the user, the user may issue navigation commands to navigate through directions file 371. Examples of the navigation commands are tabulated in FIG. 8. Each navigation command may be invoked by a corresponding DTMF tone generated by pressing a corresponding numeric key on a telephone keypad, or by uttering the command recognizable by speech recognizer 317. For example, an invocation of a “First” command, corresponding to a “DTMF 4” key, resets pointer 873 to point at the Beginning of Directions indicator. That is, the value of field 875 of pointer 873 is overwritten with the memory address of the Beginning of Directions indicator. Processor 301 then causes text-to-speech converter 315 to re-read from the first direction based on the new memory address in field 875. Similarly, an invocation of a “Back” command, corresponding to a “DTMF 1” key, results in a change in the value of field 875 of pointer 873, thereby causing converter 315 to read from the previous direction. An invocation of a “Forward” command, corresponding to a “DTMF 3” key, results in a change in the value of field 875 of pointer 873, thereby causing converter 315 to read from the next direction. An invocation of a “Help” command, corresponding to a “DTMF 2” key, results in a listing of available commands and the keys and functions corresponding thereto. An invocation of a “How far” command, corresponding to a “DTMF 5” key, results in informing the user of the distance for the rest of the route from the point where the last direction is completed, and the memory address of such last direction is indicated in field 875 of pointer 873. Processor 301 determines the distance in question by adding the mileages associated with the remaining directions. An invocation of “Go to Direction N” command, corresponding to a “DTMF 6” key followed by a “DTMF N” key, results in a change in the value of field 875 of pointer 873, thereby causing converter 315 to read from the Nth direction. Other commands and corresponding keys may be directed to reading of other data in file 371, e.g., the origination point, destination point, number of directions, total distance of the route, estimated driving time, etc.

Refer now to FIG. 9 which depicts a direction reading routine, whereby converter 315 reads a direction from directions file 371 based on the direction memory address value of field 875 in pointer 873, as indicated at step 703. Processor 301 at step 706 updates pointer 873 and in particular the value of field 875 to indicate the memory address of the last read direction. Processor 301 at step 709 determines whether the final direction in file 371 has been read. To that end, processor determines whether the value in field 875 equals that in field 877 of pointer 873. As mentioned before, field 877 contains the memory address of the final direction. If it is determined that the final direction has been read, i.e., the value of field 875=the value of field 877, the subject routine comes to an end. Otherwise, if the final direction has not been read, i.e., the value of field 875<the value of field 877, the subject routine proceeds to step 712 where processor 301 determines whether the user has signaled to end the current installment of directions, e.g., by hanging up the call, thus generating a disconnection supervisory signal. Alternatively, the user may signal to end the current installment by pressing a predetermined key(s) on the keypad. If it is determined that the user has not hung up the call, the subject routine returns to step 703 described before. Otherwise, the subject routine again comes to an end. In addition, processor 301 converts the memory address of the last read direction in field 875 to the corresponding offset address. This offset address is communicated to directions server 145 and is stored in the corresponding field 875 of the original file 371 in memory 220. The file 371 in memory 320, which is a copy, may be deleted later on.

Continuing the above example, let's say after hearing a first installment consisting of the first three directions, the user hangs up and manages to follows those directions. The user then needs a second installment of directions. In accordance with the invention, the user can call IVR unit 131 directly for subsequent installments using the IVR unit access phone number previously provided to him/her by the operator. When the user calls the access phone number, communications interface 305 in IVR unit 131 picks up the call. Processor 301 obtains from interface 305 an automatic number identifier (ANI) of the call, which is the user's MDN in this instance. Based on the user's ANI, processor 301 identifies from the aforementioned look-up table any directions file having the nnnnnnnnnn portion of the filename matches the user's ANI. If there is only one such file, processor 301 automatically requests the directions file from directions server 145. If there is more than one as the user may have requested directions for different routes, processor 301 queries the user for the <route_id> file extension of the desired file previously provided to him/her by the operator. Alternatively, processor 301 causes recitations of all possible <route_id> file extensions one by one to refresh the user's memory. If the user cannot recall the <route_id> file extension, processor 301 compiles a list of the directions files pertaining to the user, arranged chronologically with the first file in the list from which directions are most recently read to the user. The user can select the desired file by pressing a designated key on the telephone keypad, or by saying “Select this file.” Otherwise, the user can say “No,” or press another designated key on the keypad to signal processor 301 to skip to the next file.

Once the desired directions file is identified, say, file 371, processor 301 requests a copy of the file from directions server 145. Since the third direction was last read to the user in this instance, field 875 of pointer 873 in file 371 currently contains the offset address of the third direction, i.e., 0080. After converting such an offset address in field 875 to the corresponding memory address in the manner described before, based on this memory address, processor 301 causes converter 315 to read the second installment starting from the next, fourth direction, in accordance with the direction reading routine of FIG. 9. The above-described process similarly follows for obtaining subsequent installments of directions.

The service of providing directions to a user can be enhanced with the knowledge of the user's geographic location at the time the user requests the service. To that end, a global positioning system (GPS) receiver may be incorporated in the user's communication device, e.g., mobile phone in this instance. Other well known mobile handset location techniques may be incorporated, instead, which include, e.g., a wireless network based triangulation technique. In a conventional manner, the GPS receiver receives signals from a constellation of GPS satellites, and based on the received signals determines the geographic coordinates (e.g., longitude and latitude) of the current location of the user's mobile phone, and thus the user. When the user utilizes the mobile phone incorporating the GPS device to call an operator in information/call center 100 or IVR unit 131, GPS information concerning the location of the user is automatically communicated thereto, along with other call set-up signals such as an ANI. In this illustrative embodiment, the GPS coordinates of all location points covered by each direction, including the start point and endpoint thereof, are also provided in the directions file. It should be noted that the endpoint of each direction is the same as the start point of the next direction. After accessing the appropriate directions file in a manner described before, processor 301 in IVR unit 131 identifies the most relevant direction in the directions file to the received user's location. A direction is said to be the most relevant if, of all of the directions in the file, that direction covers a location point closest to the user's location. For example, processor 301 may identify the most relevant direction having an endpoint closest to the user's location, and causes converter 315 to start reading from that direction. Any GPS information concerning a user's current location is provided as well to user locator 160.

By way of example, let's say the user has listened to a first installment of directions to the Green Gables Motel in file 371 described before. The last direction read to the user by IVR unit 131 is the third direction, i.e., “Take MD. Route 3 North Towards Baltimore.” Thus, field 875 of pointer 873 at this point contains the memory address of the third direction, i.e., 1240. Let's further assume that the user had a prior experience driving to the Green Gables Motel via a similar route, and after following the first installment of directions, the user partly recalls the route to the motel. Thus, the user proceeds without calling IVR unit 131 for the remaining directions. However, after getting on highway I-95 North, the user is no longer sure about the route. The user then calls the IVR unit 131 via his/her mobile phone, incorporating the aforementioned GPS receiver therein which provides the GPS coordinates of the phone, and thus the user. After interface 305 receives the call which includes information concerning the ANI and the user's GPS coordinates, processor 301 accesses the appropriate directions file, say, directions file 371, in a manner described before. Processor 301 compares the GPS coordinates of the user with those of the endpoint of each direction in file 371, thereby identifying a particular endpoint which is closest to the user's location. Processor 301 further identifies the direction having that particular endpoint, and causes converter 315 to start reading from the identified direction. Processor 301 then adjusts the value of field 875 of pointer 873 to the memory address of the identified direction. In this example, processor 301 determines that the user is closest to the endpoint of the eleventh direction “Take New Jersey Turnpike North and Proceed.” Thus, processor 301 causes converter 315 to read the eleventh direction, and accordingly changes the value of field 875 to the memory address of the eleventh direction, i.e., 1304 in this instance. Converter 315 continues to read the remaining directions to the user, in accordance with the direction reading routine of FIG. 9. It should be noted that even if the user does not immediately relate to the initial direction read to the user (i.e., the eleventh direction in this instance), which may be one or more directions too advance, the user can always invoke the aforementioned Back navigation command to adjust to the correct starting direction. Thus, with the knowledge of the user's current location, IVR unit 131 can efficiently provide to the user the directions relevant to the user location, i.e., starting from the eleventh direction, as opposed to the directions immediately following the last installment, i.e., starting from the fourth direction.

The knowledge of the user location is important especially when the user significantly deviates from the planned route and is assumed lost, or when the user realizes that he/she has gotten lost. In either case, when the user calls IVR unit 131 for a new installment of directions, processor 301 compares the GPS coordinates of the user with those of the location points of each direction in file 371, and determines that the user deviates from the closest location point by more than a predetermined distance. Processor 301 may then warn the user of the significant deviation and suggest that the user retrace his/her path back to the planned route. Processor 301 may thereafter deliver to the user an installment starting from the last read direction to help refresh the user's memory of some of the roads that the user may have traveled before his/her “lost” state. As an alternative, processor 301 may transmit the GPS coordinates of the user and those of the closest location point in the planned route to directions server 145 via the daemon process, and request same to formulate another route to help the user to return from his/her lost location to the planned route. In either event, as soon as the user is back on the planned route, upon request by the user for an installment of directions, processor 301 delivers an installment starting from the most relevant direction as described before.

As a second alternative, a new route may be formulated from the lost user location to the same destination as the original planned route as if the user started a new trip from such a location. In that case, for example, when the user calls an operator and declares that he/she has gotten lost, the user's GPS coordinates from the call can be directly imported to directions server 145 as the origination point, provided that the map server is GPS based. Otherwise, a translation of the GPS coordinates to the actual address needs to be performed. The destination point may be imported from file 371 if it can be readily identified by the user. Otherwise, the user may provide the destination address again. The whole process is performed as if the user were planning a new route. The resulting route is then read to the user by IVR unit 131 in the manner described before.

The installments of directions may be obtained with various communication and information services. For example, the installments may be obtained using a “StarBack” feature in a directory assistance service. To fully appreciate the StarBack feature, let's assume a user calls an operator in an information/call center (e.g., center 100) for directory assistance, e.g., requesting a desired destination number and a transfer to that number. As mentioned before, when the user calls an operator in center 100, the user's call is connected to switch 114 therein. It should be noted that such a connection to switch 114 is intact even after the call is transferred to the destination number as long as the user does not hang up. A DTMF receiver is allocated in switch 114 to monitor for a predetermined signal from the user connection for the entire duration of the call in case the user may require further operator assistance. By way of example, the predetermined signal is a DTMF signal generated by pressing a “*” (star) key on the phone. Thus, the “StarBack” feature enables a user, who called for operator assistance, to re-summon an operator by pressing a “*” key as long as the user never hangs up. When the DTMF receiver detects the “*” key signal, the re-summoning of an operator appears as a fresh call to the ACD logic. This in turn results in the user being connected to an available operator. Note that the operator to whom the call is connected is allocated according to the ACD logic, and may or may not be the operator that previously handled the user's call. The StarBack feature can be repeatedly invoked in a call connected through switch 114 before the user hangs up.

Thus, by taking advantage of the StarBack feature, the user can obtain directions in installments. For example, after the user calls an operator in information/call center 100, and receives a first installment of directions from the operator, he/she can summon further installments as needed along the route simply by pressing the “*” key. (Although in this example the directions are read by an operator, it is apparent from the disclosure heretofore that IVR unit 131 can readily take the place of an operator to read the directions.) In such an implementation, the user's connection to information/call center 100, and in particular switch 114 therein, is maintained during the course of the trip. However, the operator can attend to other users while the traveling user does not need the operator's immediate attention. Similar to directions file 371, a file, e.g., in hypertext markup language (HTML), from which the directions are read by the operator to the user has a pointer associated therewith, which is used to indicate the last read direction within that file. This HTML file is cached after the operator delivers to the user the requested installment so that the file can be promptly retrieved and opened upon detection of a StarBack signal. Since “StarBack” may return the user to a second, different operator, this second operator at terminal 120 may enter a “last route” command to pick up where the last operator left off. In response, the HTML file is retrieved and opened on terminal 120 and the last read direction therein is automatically marked by the associated pointer. The second operator then delivers a second installment starting from the next direction in the file. While driving between operator directions, the user is simply kept in a “hold” state. Of course, instead of utilizing the StarBack feature to keep the current call on hold, the user can repeatedly call an operator anew, e.g., using the “last number dialed” feature on the phone, to achieve the same result.

In accordance with a first embodiment of the invention, a user's progress along his/her planned route defined by the directions requested by the user is tracked. At the same time, conditions along the user's route are monitored, and if an event is detected that may affect the user's progress, the user is contacted and a message is delivered notifying him/her of the event. In addition, one or more advertisements, offers and/or suggestions of goods or services in view of the event are delivered to the user along with the message.

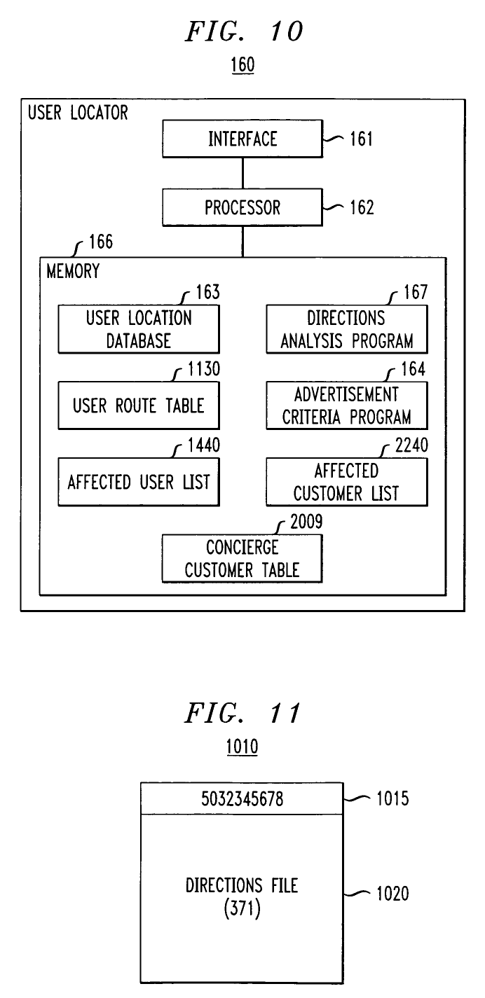

Users' progresses along their planned routes are tracked by user locator 160. FIG. 10 is a block diagram illustrating components of user locator 160. User locator 160 illustratively includes interface 161 through which locator 160 is connected to data network 124, processor 162, and memory 166. In this example, memory 166 includes therein user location database 163, user route table 1130, affected user list 1440, concierge customer table 2009, advertisement criteria program 164, and directions analysis program 167. When directions server 145 receives a directions file associated with a respective user, it sends a copy of the file is to user locator 160, which is used by processor 162 to create a user location folder in database 163. For example, when Mary's directions file 371 is received, processor 162 creates a user location folder such as folder 1010 shown in FIG. 11 in database 163. Folder 1010 includes identifying data record 1015, which holds Mary's telephone number derived from the filename of directions file 371, which is “5032345678” in this example, and directions file record 1020, which holds a copy of Mary's directions file 371. Subsequently, each time information is received from IVR unit 131 concerning an update to pointer 873, processor 162 makes a corresponding change to the information in Mary's user location folder 1010, and in particular record 1020.

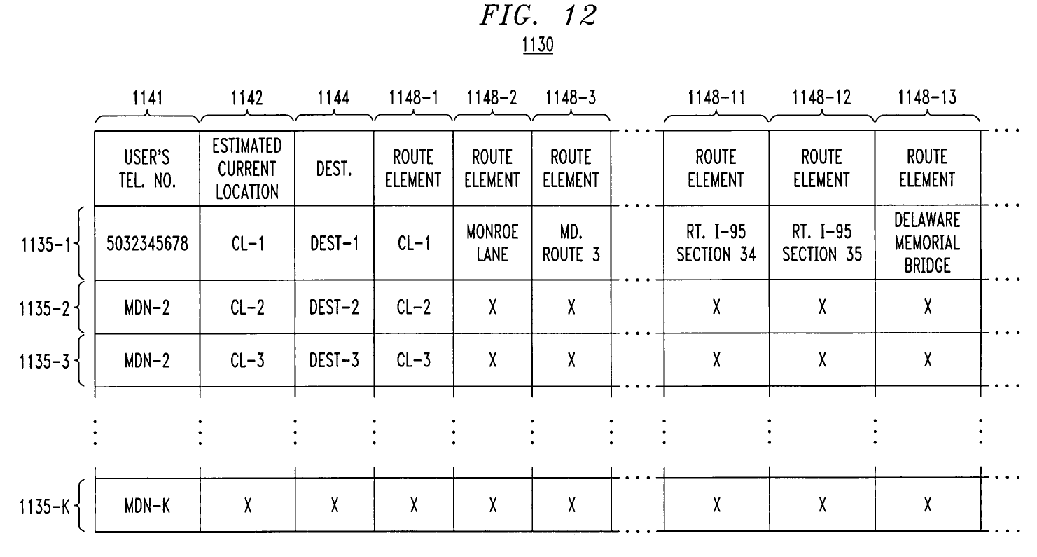

User locator 160 also maintains user route table 1130 to track the progress of various users along their planned routes. FIG. 12 illustrates user route table 1130, which comprises user route records 1135-1 through 1135-K associated with K different users. Field 1141 of each user route record holds an identifier of the user such as the user's telephone number. Field 1144 holds data, e.g., in the form of GPS coordinates, indicating the user's destination (e.g., DEST-1) which is derived from the user's directions request. Field 1142 holds data indicating the estimated current location of the user (e.g., CL-1). In this illustrative embodiment, the estimated current location data represents an approximation of the user's location when the user last contacted the information assistance service. For example, when a user route record (say, Mary's record 1135-1) is created, a key term (or GPS coordinates) representing the start point of the first direction in the user's directions file record 1020 is initially entered in field 1142. Such a key term may be generated using directions analysis program 167 described below. Alternatively, if the user's actual GPS coordinates are known (for example, from signals received from the user's GPS enabled communications device), they may be entered into field 1142. Subsequently, each time information is received from IVR unit 131 concerning an update to pointer 873 in the user's directions file 371, unit 131 communicates the same to locator 160, along with the user' telephone number derived from the filename of file 371. Processor 162 identifies folder 1010 based on the user's telephone number matching that of record 1015. However, before the corresponding pointer in record 1020 in folder 1010 is updated, processor 162 reads the endpoint of the last direction at which the pointer in record 1020 is pointing. Assuming that the user is currently located close to or at such an endpoint since he/she is receiving a new installment of directions, processor 162 revises the estimated current location data in field 1142 of the user route record by inserting therein the key term (or GPS coordinates) representing the endpoint as read. Processor 162 then updates the pointer in record 1020 to conform to updated pointer 873.

Processor 162 additionally maintains a set of key terms (or GPS coordinates) representing location points of the unfinished portion of the planned route to be traversed by the user starting from the estimated current location in field 1142. Included among such location points are the endpoints of all directions concerning the unfinished portion of the planned route. Processor 162 populate these key terms (or GPS coordinates) in route element fields 1148-1, 1148-2, 1148-3, etc., where route element field 1148-1 contains the same key term (or GPS coordinates) as estimated current location field 1142. It should be noted that fields 1142, 1148-1, 1148-2, 1148-3, etc. are updated each time when pointer 873 is updated, reflecting the user's supposed progress along the planned route. At such time, the contents of the route element fields of the user route record in table 1130 are shifted from right to left until field 1148-1 contains the same content as field 1142, which would have been updated in the manner described above in response to an update of pointer 873. As a result, the route elements which the user presumably has passed are eliminated from the user route record.

By running directions analysis program 167, processor 162 may examine the directions in a user's directions file and extract key terms representing location points, i.e., certain points/sections of roads, highways, bridges, etc., of the planned route mentioned in the file. Thus, for example, processor 162 may access Mary's user location folder 1010 based on her identifier “5032345678,” which is Mary's telephone number. Processor 162 then examines the directions file in record 1020, and extracts the names of roads, highways, and other words descriptive of various location points of the planned route in the directions file.

Referring to user route record 1135-1, which is associated with Mary identified by her telephone number “5032345678” in field 1141, her estimated current location is denoted CL-1 in field 1142. Mary's destination is the Green Gables Motel in Atlantic City, N.J., denoted DEST-1 in field 1144. Route element fields 1148-1, 1148-2, 1148-3, . . . contain key terms representing points/sections of roads, highways, bridges, tunnels, etc. that are located along the Mary's itinerary starting from the estimated current location in field 1142. In this instance, the route elements in fields 1148-1, 1148-2, 1148-3 . . . are CL-1, Monroe Lane, Md. Route 3 . . . , respectively.

Event monitor 163 in FIG. 2 monitors occurrences of events, and weather and traffic conditions in one or more regions, e.g., by accessing news, weather, traffic, emergency information channels, reports, websites and other information sources. For example, monitor 163 would inform user locator 160 of such notable events as closures of particular roads, bridges and tunnels; traffic congestions in particular sections of highways; severe thunderstorms and flooding in particular areas; parades in particular streets; delays and service interruptions of particular ferries, buses, trains and flights; etc., which may affect a user's travel.

If a notable event is detected, event monitor 163 sends an event message to user locator 160 containing a description of the event, a set of GPS coordinates representing the location of the event, and a set of route elements that may be affected by the event. Event monitor 163 applies a predetermined set of business rules to map information stored, e.g., in database 20, to identify route elements that may be affected by a given event. The map information stored in database 20 stores data representing roads, highways, bridges, tunnels, etc., in one or more regions. Roads and highways are divided into sections corresponding to route elements. The map information also includes GPS coordinates representing each route element.

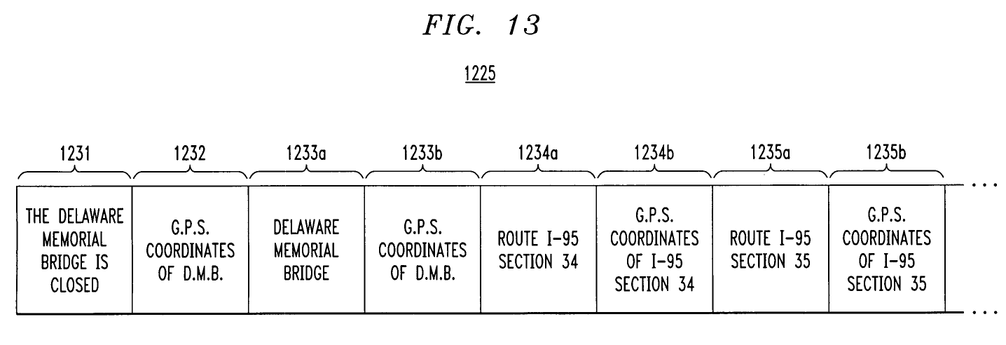

For example, supposing that a storm causes the Delaware Memorial Bridge (D.M.B.) to be temporarily closed, event monitor 163 may generate an event message such as that shown in FIG. 13. Message 1225 comprises field 1231 which holds a description of the event, in this instance, “The Delaware Memorial Bridge Is Closed.” Field 1232 contains the GPS coordinates representing the location of the event, in this instance GPS coordinates of the Delaware Memorial Bridge. Each pair of fields 1233a-b, 1234a-b, 1235a-b, etc., contain data (a key term and GPS coordinates, respectively) representing a route element that may be affected by the event. In this instance, fields 1233a and 1233b contain a key term and GPS coordinates representing the route element Delaware Memorial Bridge, respectively. Fields 1234a and 1234b contain a key term and GPS coordinates representing a first section of Route I-95 (e.g., Section 34), respectively. Fields 1235a and 1235b contain a key term and GPS coordinates representing a second section of Route I-95 (e.g., Section 35), respectively. It should be noted that, although only three affected route elements are shown in FIG. 13, an event message may contain more or fewer route elements depending on the actual circumstances surrounding the event. Event monitor 163 transmits message 1225 to user locator 160.

Upon receiving event message 1225, processor 162 in user locator 160 retrieves from field 1232 the GPS coordinates of the event, and the affected route elements, e.g., from fields 1233a, 1234a, 1235a, etc., and uses this information to determine which users should be contacted and notified of the event in question. As processor 162 identifies users that may be affected by the event (referred to as affected users), the affected users are added to affected user list 1440 stored in memory 166.

To determine which users may be affected by the event in question, processor 162 accesses user route table 1130 and examines the user route records therein. Referring to FIG. 14, at step 1340 processor 162 selects a user route record, e.g., Mary's user record 1135-1, from user route table 1130. Processor 162 then determines if any of the route elements listed in record 1135-1 are listed in event message 1225. Accordingly, processor 162 at step 1345 retrieves a route element from record 1135-1. In examining record 1135-1, processor 162 examines the route elements in fields 1148-1, 1148-2, 1148-3 . . . in that order. Thus, processor 162 begins by selecting the route element in field 1148-1, i.e., CL-1 in this instance. Referring to block 1350, because CL-1 is not listed in message 1225, the routine proceeds to block 1353. Because there are more route elements listed in record 1135-1, the routine returns to step 1345, and the next route element is retrieved from user record 1135-1. The routine examines each element listed in record 1135-1 in this manner until a route element is identified which is listed in message 1225, or until all route elements in record 1135-1 have been examined without finding a match. When a route element is found in a user route record that is also listed in message 1225, such a route element is referred to as a “matching route element,” and the corresponding user is referred to as an “affected user.”

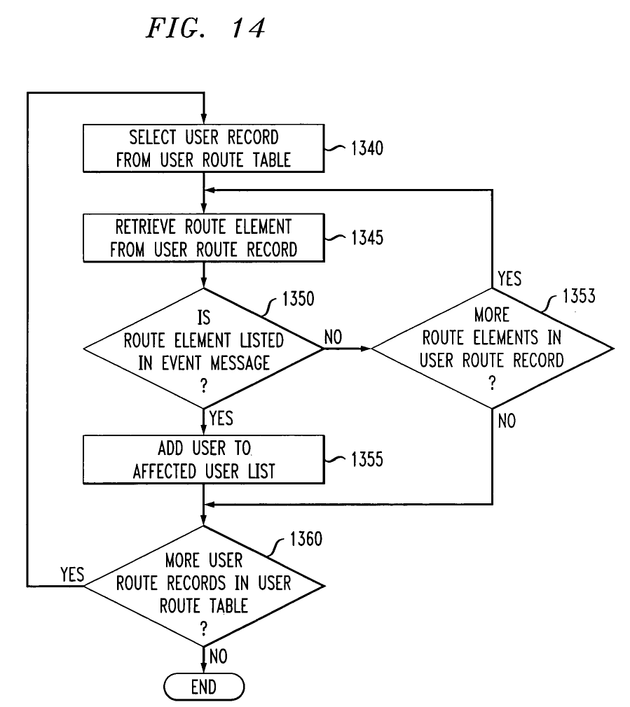

In this example, processor 162 continues to examine route elements in record 1135-1 until it determines that “Route I-95 Section 34,” contained in field 1148-11, is listed in event message 1225. Accordingly, the routine proceeds to step 1355 where processor 162 adds Mary's identification data to affected user list 1440. FIG. 15 shows affected user list 1440 in which Mary identified by her telephone number is included as an affected user in record 1460. Processor 162 enters Mary's telephone number, “5032345678,” (taken from field 1141 of record 1135-1) in field 1442, the description of the event (taken from field 1231 of message 1225) in field 1443, and the GPS coordinates of the matching route element in field 1444 (taken from field 1234a of message 1225). Field 1445 contains a binary flag which indicates whether Mary is currently located within a predetermined radius of the event, e.g., 50 miles (flag value “1”) or not (“0”). Processor 162 determines the distance from Mary's estimated current location (i.e., CL-1 in table 1130) to the event in question. Such determination may involve conversion of CL-1 to the corresponding GPS coordinates if it is not already in GPS coordinates, and a distance calculation based on the GPS coordinates representing CL-1 and the GPS coordinates representing the event (indicated in field 1232 of message 1225). If it is determined that Mary's estimated current location is within the predetermined distance of the event, which is the case here, processor 162 enters a ‘1’ in field 1445 of record 1460.

Returning to FIG. 14, after Mary has been added to affected user list 1440, the routine proceeds to block 1360. If user router table 1130 contains more unexamined user route records, the routine returns to step 1340 and another user routed record is selected for examination. Affected user list 1440 thus includes users who may be affected by the event indicated in message 1225. It should be noted that affected user list 1440 also includes users who may be affected by other events represented by other event messages. For example, record 1461 corresponds to a user whose travel plans may be affected by a “parade in Times Square.”

Instructed by advertisement criteria program 164, processor 162 regularly checks affected user list 1440 and contacts selected users therein. Referring to FIG. 16, at step 1610 processor 162 examines list 1440 and retrieves a record, e.g., record 1460 which corresponds to Mary. At step 1620, processor 162 examines field 1445 to verify whether or not Mary is within the predetermined radius of an event. If a user is not within the affected radius, i.e., “0” in field 1445, processor 162 selects another record within list 1440 for examination. In this instance, however, field 1445 of record 1460 contains a “1” value. Processor 162 proceeds to generate one or more advertisement criteria relevant to Mary's circumstances. To this end, processor 162 at step 1630 collects context information relating to Mary's circumstances including any alternative transportations (e.g., ferry, plane, etc.), food and shelter needs, etc., along with the GPS coordinates of the matching route element from field 1444. Processor 162 may additionally utilize Mary's telephone number to access user route record 1135-1 and determine the distance from the event to Mary's final destination, another piece of context information. Processor 162 may also collect objective information such as the time of day, and weather and traffic conditions in the vicinity of the matching route element, etc.

At step 1640, processor 162 applies a set of predetermined inferential rules to the context information and the objective information to determine criteria for relevant advertisements, suggestions and offers to the user. For example, processor 162 may infer from context information and objective information that an advertisement for a restaurant in the vicinity of the matching route element may be appropriate to the user's needs, because it is close to lunch time. Alternatively, processor 162 may determine that an advertisement for hotel accommodations in the vicinity of the matching route element is appropriate because of inclement weather or lateness at night.

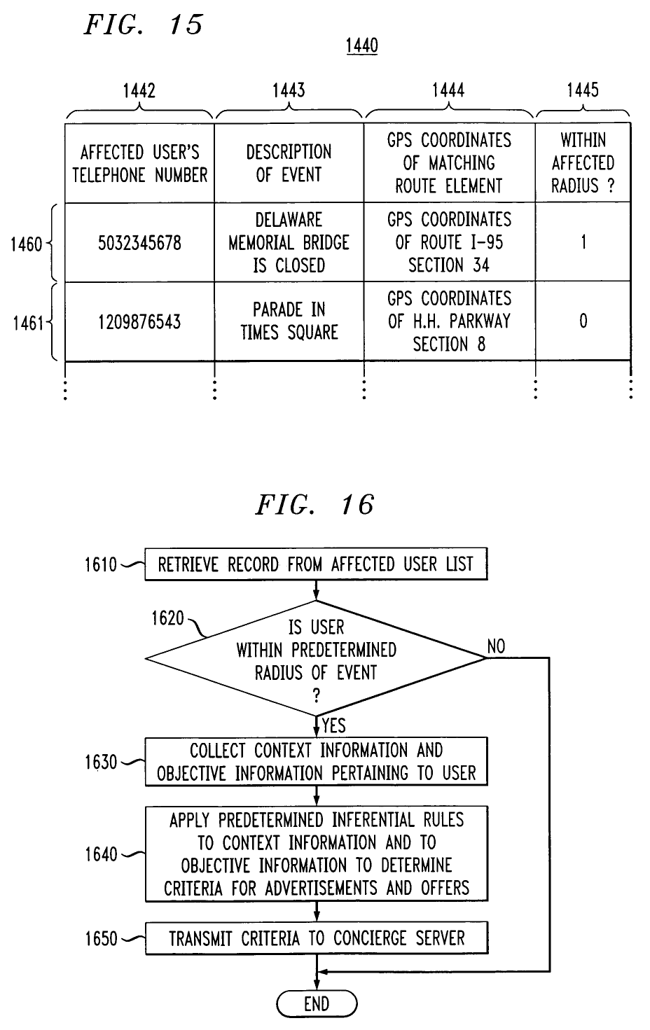

By way of example, processor 162 in this instance determines from record 1460 that Mary may experience delays when she arrives at the matching route element, i.e., Route I-95 Section 34. Processor 162 additionally consults user record 1135-1 in table 1130 and determines that Mary is headed toward Atlantic City, N.J., which is several hours travel time from Route I-95 Section 34. To supplement this context information, processor 162 additionally considers the time of day. Supposing the time is 11:30 a.m., processor 162 may determine that advertisements for restaurants in the vicinity (e.g., within five miles) of Route I-95 Section 34 is appropriate for Mary. Supposing, on the other hand, that the time of day is 1:00 a.m., processor 162 may determine instead that advertisements for hotels or lodging in the vicinity of Route I-95 Section 34 is appropriate. Once advertisement criteria have been determined, processor 162 transmits the advertisement criteria, and Mary's telephone number, to concierge server 171 (step 1650). Processor 162 may transmit the advertisement criteria in the form of a message denoted 3300 in FIG. 17. As illustrated in FIG. 17, message 3300 includes user identifying data field 3320 which contains Mary's telephone number, and fields 3321, 3322, 3323, . . . , each holding data representing one or more advertisement criteria. For example, field 3321 contains “RESTAURANT,” field 3322 holds “WITHIN FIVE MILES,” and field 3323 contains the GPS coordinates of Route I-95 Section 34.

An object of the invention is to limit the number of advertisements sent to a user, and at the same time provide useful information to the same. To that end, processor 162 may individualize the advertisement criteria to tailor the advertisement(s) further to the user's needs. For example, knowing from Mary's user profile (described below) that she prefers Italian cuisine, processor 162 may individualize the advertisement criteria by adding an additional field specifying Italian cuisine to message 3300 to be transmitted to concierge server 171. The resulting advertisement criteria specify those advertisements of Italian restaurants within five miles of Route I-95 Section 34.

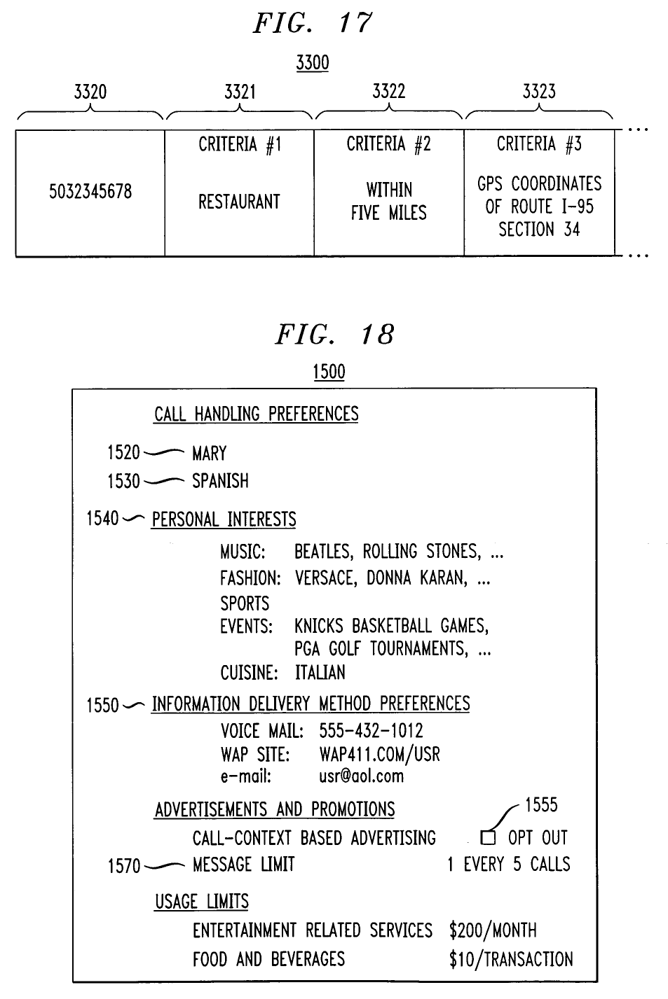

FIG. 18 illustrates user profile record 1500 associated with the user Mary in this instance. Record 1500 contains user preferences including those initially specified by Mary during a registration with the information assistance service, which may be subsequently modified. As shown in FIG. 18, record 1500 includes such user preferences as how Mary wishes to be addressed by the operator (e.g., “Mary” denoted 1520) and what language she prefers when interacting with system 30 (e.g., “Spanish” denoted 1530).

In another embodiment, knowing Mary's language preference, i.e., Spanish in this instance, processor 162 may further cause the advertisements to be delivered to Mary be in Spanish. In addition, record 1500 contains information concerning a user's personal interests 1540, which may be used for tailoring advertisements to the user. For example, at the conclusion of an information assistance call, such advertising information may be “pushed” to the user, subject to any opt-out provision 1555 in the profile record. In this instance, Mary specifies as part of personal interests 1540 preferred music, e.g., Beatles, Rolling Stones, etc.; fashion, e.g., Versace, Donna Karen, etc.; sports events, e.g., Knicks basketball games, PGA Golf tournaments, etc.; and cuisine, e.g., Italian.

The advertisements may also be delivered to the user via alternative forms and/or methods, e.g., SMS, e-mail, WAP, voicemail, facsimile, paging, instant messaging, text messaging, video phone, picture phone, etc. For example, the actual method(s) of delivery of the advertising information may be specified by the user in user profile record 1500, shown as information delivery method preferences 1550. Such information delivery method(s) may be established in the initial registration by the user in response to such direct questions as “How do you want advertising information to be transmitted to you from an information assistance service?” The answers to such direct questions may make up preferences 1550. The specified delivery methods may be prioritized in accordance with the user's preferences.

FIG. 19 is a block diagram illustrating components of concierge server 171, including interface 194 for connecting server 171 to data network 124, processor 193, and memory 196. Memory 196 contains advertisement database 197 and advertisement listing database 1137. Upon receiving message 3300 containing the advertisement criteria from user locator 160, concierge server 171 searches advertisement listing database 1137 for advertisements satisfying the criteria. Advertisement listing database 1137 includes a list of records associated with various advertisements stored in advertisement database 197. Each record corresponds to a respective advertisement and includes a unique identifier for the advertisement, and additional data indicating selected attributes thereof, e.g., type of product or service (restaurant, hotel, car rental, etc.), location (of restaurant, for example), time of day the product or service is available, etc. In the illustrative example, processor 193 searches database 1137 for advertisements for Italian restaurants located within five miles of Route I-95 Section 34. Processor 193 may identify an advertisement for an Italian restaurant named “Alfonso's Olive Garden” which satisfies the criteria, for example.

After identifying one or more relevant advertisements, processor 193 in concierge server 171 retrieves the selected advertisement(s) or suggestion(s) of goods or services from advertisement database 197. Processor 193 then causes IVR unit 131 to contact Mary, e.g., using her telephone number, and deliver a notification of the event in question, e.g., “This is the ABC information assistance service. We are calling to inform you that the Delaware Bridge is closed.” Processor 193 also causes IVR unit 131 to provide the selected advertisement(s) or suggestion(s) of goods or services to Mary during the event notification call.

In one embodiment, an advertisement or a goods or services suggestion delivered to a user is accompanied by an offer to order or reserve the goods or services for the user, e.g., an offer to make a restaurant or hotel reservation for the user. In the illustrative example, concierge server 171 may cause the following advertisement/offer to be delivered to Mary subsequent to the event notification during the same call:
“We would be pleased to make a reservation for you for lunch at Alfonso's Olive Garden, an Italian restaurant located at 32 Route 64 in Horton, Del., three miles south of the Delaware Memorial Bridge. Please press ‘1’ or say “Yes” if you would like to make a reservation.”

Supposing that Mary presses ‘1,’ in response concierge server 171 may further assist Mary by requesting the number of parties to realize the reservation, asking whether she needs directions to the restaurant, etc. Of course, the call may also be transferred to an operator anytime, say, by pressing “0,” for additional assistance. Preferably, the call is transferred to a selected operator who possesses extensive knowledge of local custom, language, culture, geography, etc. of the area in which the user is anticipated to need guidance. In general, concierge server 171 is used by the information assistance service to provide concierge services, which include, inter alia, restaurant guide and reservation services, event information, ticketing and reservation services, hotel reservation and availability services, travel or flight reservation and ticketing services, ordering specific items such as flowers or food delivery, arranging transportation, and accessing entertainment guides. In particular, relying on concierge server 171, an information assistance service provider may make a reservation at a selected restaurant or hotel at a user's request. For details on concierge services by an information assistance service provider which involve conducting on-line reservations and transactions for a user, one may refer to copending, commonly-assigned application Ser. No. 10/366,816, filed Feb. 14, 2003, which is incorporated herein by reference.

Concierge service inquiries, reservations and transactions are handled by concierge server 171. The information concerning providers of desired products or services, e.g., their names, addresses, business hours, URLs, contacts, etc. may be shown and formatted in fields of a graphical user interface (GUI) appearing on the display of an operator's terminal 120. Similarly, the specifications, prices and schedules, etc. of desired products or services are also shown and formatted in fields of a GUI. Concierge server 171 in this instance also keeps records as to what products or services, and what product or service providers have advertisements thereof in advertisement database 197 to be “pushed” to the users under contractual terms with advertisers. The actual advertisements may be stored in different forms (e.g., audio, text, graphics, video, etc.) in advertisement database 197. An advertisement indicating field may be provisioned next to a product, a service, or a product or service provider located and shown on a GUI to indicate whether an advertisement is available therefor.

In the second embodiment of the invention, when a user calls the information assistance service, information concerning the current location of the user handset is received by information/call center 100, along with other call set-up signals such as ANI. As mentioned before, such location information may be generated by the user's communications device incorporating, e.g., a GPS receiver, or by other means including use of the wireless network triangulation technique. Let's say the user during an information assistance call requests a concierge service, e.g., reserving for the user movie tickets at a specified cinema, for a desired showtime. Knowing such destination (the specified cinema) and time of arrival (the desired showtime), the information assistance service may track the user's progress to the destination, in accordance with the invention. Such tracking is realizable if the user makes additional calls to the information assistance service, thus providing additional GPS information concerning the user's location accompanying the calls. It is likely that the user frequently calls the information assistance service to take advantage of the many different services offered thereby including, e.g., providing directory assistance, concierge services, directions and weather, traffic, horoscope, flight schedule and other information, and access to the user's private calendars and directories maintained by the information assistance service. If an event is detected that may affect the user's travel toward the cinema or delay the showing of the movie itself, a call will be placed to the user, notifying the user of the event. In addition, one or more advertisements, suggestions and/or offers for goods and services according to the circumstances are delivered to the user during the call.

By way of example, suppose that a user named Emeric calls the information assistance service using a GPS-enabled mobile phone, and requests that the operator reserve tickets for the movie “Star Wars” at the Plaza Cinema in White Plains, N.Y. Specifically, Emeric requests two tickets for the 8:00 p.m. show. During the call, signals from Emeric's telephone containing GPS coordinates of his current location and ANI are received. In response to Emeric's request, the operator utilizes concierge server 171 to reserve two tickets for the requested movie. After the service has been rendered, concierge server 171 transmits a message to user locator 160 containing information about the user and the requested concierge service. Specifically, concierge server 171 transmits a message containing Emeric's telephone number derived from the received ANI, GPS coordinates of his destination (i.e., the Plaza Cinema in White Plains), GPS coordinates of his current location, the time of the information assistance call, the type of service provided, and the contact information concerning the vendor providing the desired product or service, e.g., the telephone number of the Plaza Cinema in this instance.

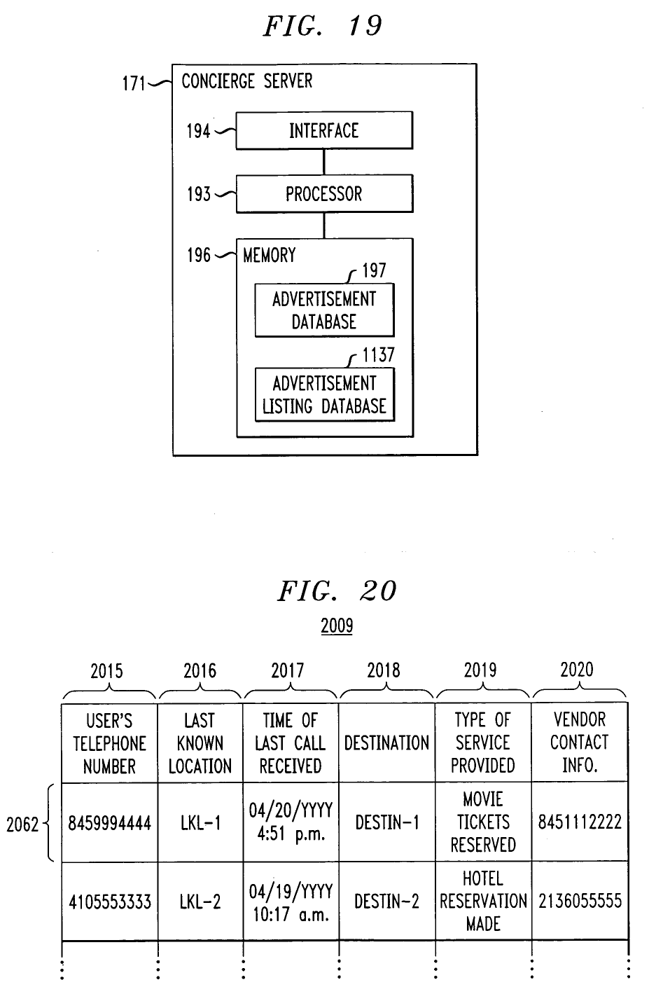

To maintain information about users of the information assistance provider's concierge services, a concierge customer table denoted 2009 in FIG. 20 is used which is stored in memory 166 of user locator 160. Upon receiving the message from concierge server 171, processor 162 in user locator 160 generates a customer record in concierge customer table 2009. For example, processor 162 may generate customer record 2062 for Emeric. Specifically, in record 2062 field 2015 contains Emeric's telephone number; field 2016 contains GPS coordinates representing his last known location (LKL-1); field 2017 contains data indicating the date and time when his last call was received (04/20/YYYY 4:51 p.m.); field 2018 contains GPS coordinates representing his destination (DESTIN-1); field 2019 contains information concerning the service provided to Emeric, e.g., “Movie Tickets Reserved” in this instance; and field 2020 contains contact information concerning the vender providing the actual goods or service desired by the user, e.g., a telephone number of the Plaza Cinema in this instance.

Subsequently, if Emeric calls the information assistance service for any reason using the same GPS enabled telephone, another set of GPS coordinates indicating his current location is received by the information assistance service, and is used to update his last known location in field 2016 of record 2062. For example, he may set out to the cinema in his car, and on the way decide to contact a colleague from work. Not having his colleague's telephone number, he calls the information assistance service to obtain directory assistance to contact his colleague. During this second call, ANI and updated GPS coordinates are received from Emeric's call. The ANI is used by user locator 160 to retrieve record 2062 by matching the telephone number in field 2015 of the record. The received GPS coordinates are used to update the content of field 2016 of record 2062. The time of the second call is registered in field 2017.

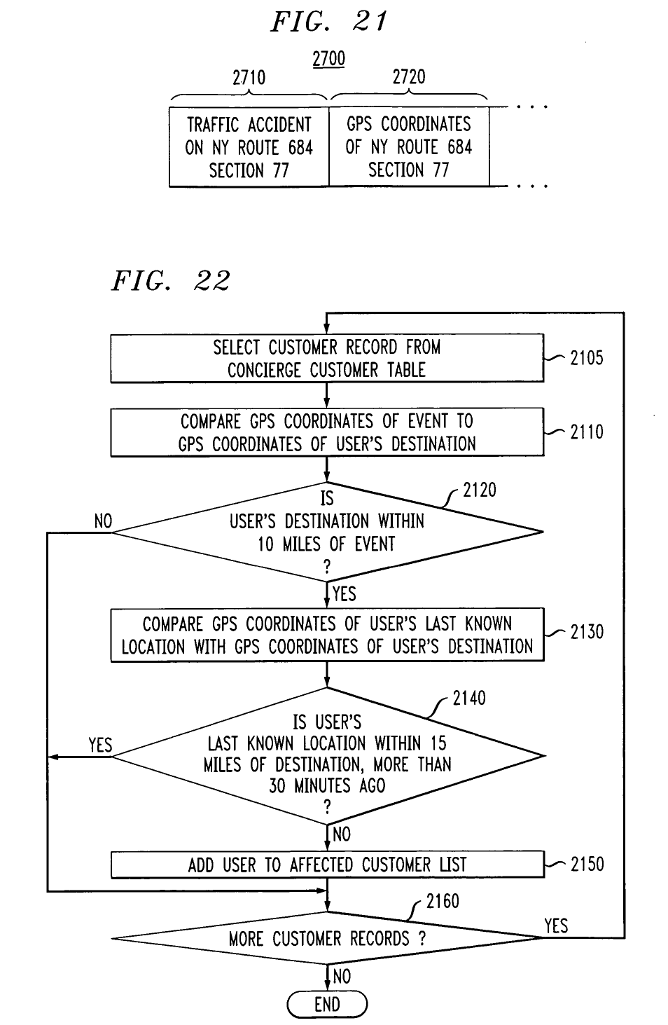

Suppose now that event monitor 163 generates an event message denoted 2700 in FIG. 21. Message 2700 illustratively includes field 2710 which contains a description of the event, in this instance, “Traffic Accident on NY Route 684 Section 77,” and field 2720 which contains GPS coordinates representing the location of the event. When user locator 160 receives event message 2700 from event monitor 163, processor 162 retrieves the GPS coordinates of the event from field 2720 and examines the customer records in table 2009 to determine which users may be affected thereby. FIG. 22 is a flowchart depicting a routine to determine if a user may be affected by an event. At step 2105 processor 162 selects a user record, e.g., Emeric's user record 2062, from table 2009. Processor 162 first analyzes Emeric's customer record 2062 to determine whether Emeric's destination lies within a predetermined radius of the event and thus may be affected thereby, e.g., by increased traffic congestion or closures of roads. Thus, at step 2110 processor 162 compares the GPS coordinates of the event with the GPS coordinates of Emeric's destination in field 2018. At step 2120, processor 162 determines if Emeric's destination is located within a predetermined distance, say, 10 miles, of the event. If so, processor 162 assumes that travel to Emeric's destination may be affected, and the routine proceeds to step 2130. Otherwise, if a user's destination is not within the predetermined radius, the routine proceeds to block 2160, and another customer record may be examined.

Supposing that Emeric's destination is located within 10 miles of the event, processor next determines whether Emeric has yet arrived at his destination. If he has, the event in question apparently does not affect his arrival thereat. In this example, processor 162 assumes that a user has arrived at the destination if the user was within 15 miles of the destination more than 30 minutes ago. Pursuant to this assumption, processor 162 at step 2140 determines whether the user's last known location (registered in field 2016) is within 15 miles of the destination (registered in field 2018) more than 30 minutes ago (by comparing the time in field 2017 and the present time). It will be appreciated that other assumptions or criteria may be used, instead, by a person skilled in the art to determine whether a user has arrived at a destination. By way of example, let's say this determination is negative in the case of Emeric. Thus, it is assumed that Emeric has not yet arrived at his destination, and may be affected by the event in question. As such, Emeric is added to the affected customer list (step 2150), and the routine then proceeds to block 2160. Otherwise, if it is determined that the user has arrived at the destination, the routine proceeds directly to block 2160 from step 2140. Referring to block 2160, the above-described routine is repeated until all customer records are examined.

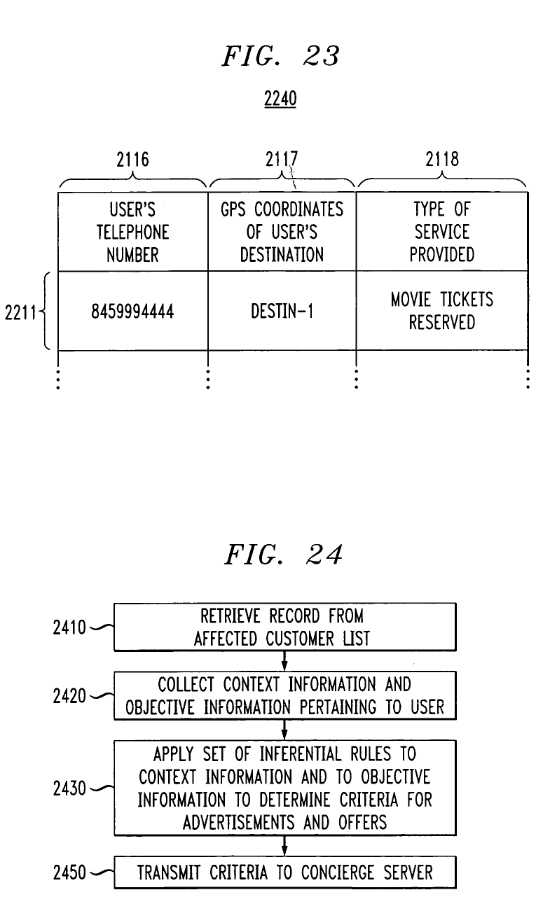

FIG. 23 shows an affected customer list 2240 stored in memory 166, in accordance with this embodiment. List 2240 comprises three fields 2116-2118, which include, respectively, a user's telephone number, GPS coordinates representing the user's destination, and data indicating the type of service provided. In this instance, Emeric's telephone number for identifying Emeric (i.e., 8459994444), the GPS coordinates representing his destination (i.e., DESTIN-1), and data indicating the type of service provided to him (i.e., Movie Tickets Reserved) are stored in record 2211 in fields 2116-2118, respectively.

Instructed by advertisement criteria program 164, processor 162 regularly checks affected customer list 2240 and contacts users listed therein. Referring to FIG. 24, at step 2410 processor 162 examines list 2240 and retrieves a record, e.g., record 2211 which is associated with Emeric. At step 2420, processor 162 collects context information relating to Emeric's needs, including the GPS coordinates of his destination from field 2116 and the type of service provided from field 2118. Processor 162 may also collect objective information such as the time of day, the weather, etc.

At step 2430, processor 162 applies a set of predetermined inferential rules to the context information and to the objective information to determine criteria for advertisements and offers. For example, in this instance processor 162 may infer from context information and objective information that Emeric may encounter delays due to the traffic accident indicated in event message 2700, and that therefore an offer to change the original ticket reservation to a later showtime may be appropriate. Once the criteria have been determined, processor 162 sends such criteria, and Emeric's telephone number to concierge server 171 (step 2450).

Upon receiving the criteria, along with Emeric's telephone number, from user locator 160, concierge server 171 prepares an offer for concierge services based on the criteria, or searches advertisement listing database 1137 for advertisements that satisfy the criteria. In the illustrative example, processor 193 prepares an offer to call the movie theater and change Emeric's movie ticket reservation to a later showtime. For this purpose, concierge server 171 may query user locator 160 for the telephone number of the cinema originally called, for example. User locator 160 retrieves the number from concierge customer table 2009 and provides this information to concierge server 171 in a response. Alternatively, server 171 may search its own records for the record concerning the ticket reservation made earlier for Emeric, which is identifiable by Emeric's telephone number, and which contains details about the earlier reservation including the telephone number of the cinema.

Processor 193 in concierge server 171 then causes IVR unit 131 to call Emeric using his telephone number and deliver a notification message such as “This is the ABC information assistance service. We are calling to inform you that there has been a traffic accident on Route 684. Traffic around White Plains may be delayed.” Processor 193 also causes IVR unit 131 to announce an offer to call the Plaza Cinema and change his reservation to a later showtime in the same call, which Emeric may accept or decline, e.g., by pressing the appropriate key on his telephone.

The foregoing merely illustrates the principles of the invention. It will thus be appreciated that those skilled in the art will be able to devise numerous other arrangements which embody the principles of the invention and are thus within its spirit and scope.

For example, in the second embodiment, the destination of a user is determined in the context of a movie ticket reservation (i.e., the cinema). However, the user's destination can similarly be determined in the context of a restaurant reservation (i.e., the restaurant), in the context of a hotel reservation (i.e., the hotel), in the context of a car rental reservation (i.e., the cities in which the rental car is picked up and dropped off), in the context of a flight reservation (i.e., the cities in which the user boards the flight and lands), in the context of a purchase of a merchandise in a department store (i.e., the department store), so on and so forth.

It is also well understood by those skilled in the art that various components of the system for implementing the invention can either be located in a single location, or be geographically distributed and in communication with one another through individual connections or a network.

Finally, information/call center 100 is disclosed herein in a form in which various functions are performed by discrete functional blocks. However, any one or more of these functions could equally well be embodied in an arrangement in which the functions of any one or more of those blocks or indeed, all of the functions thereof, are realized, for example, by one or more appropriately programmed processors.

What is claimed is:

1. A method for use by an information assistance service to assist a user, comprising:
receiving a communication from the user, the communication including a request for a service;
determining that a user is traveling to a destination based on the requested service;
determining a location of the user when the user communicates with the information assistance service to track the user's progress to the destination;
monitoring for an event affecting the user's progress to the destination; and
in response to a detection of an event affecting the user's progress to the destination, communicating, to the user, selected information to cope with a circumstance caused by the event.

2. The method of claim 1 wherein the service includes providing, to the user, directions to the destination.

3. The method of claim 2 wherein the user communicates with the information assistance service a plurality of times to obtain the directions in installments.

4. The method of claim 1 wherein the selected information includes advertising information.

5. The method of claim 4 wherein the advertising information comports with the user's preferences.

6. The method of claim 5 wherein the user's preferences are maintained by the information assistance service.

7. The method of claim 1 wherein the selected information includes a suggestion of a product or service.

8. The method of claim 1 wherein the selected information includes an offer to reserve a product or service.

9. The method of claim 1 wherein the event includes a selected one of a traffic condition, weather condition, and road condition.

10. The method of claim 1 wherein the communication includes a telephone call.

11. A method for use by an information assistance service to assist a user, comprising:
receiving a communication from the user using a communications device, the communication including a request for a concierge service;
determining that the user is traveling to a destination based on the concierge service request;
locating the communication device when the user communicates with the information assistance service, thereby tracking the user's progress to the destination;
monitoring for an event affecting the user's progress to the destination; and
in response to a detection of an event affecting the user's progress to the destination, establishing a second communication to convey selected information to the user.

12. The method of claim 11 wherein the communications device is located using a wireless network triangulation technique.

13. The method of claim 11 wherein the communications device is located based on global positioning system (GPS) information provided by the communications device.

14. The method of claim 11 wherein the communications device comprises a mobile telephone.

15. The method of claim 11 wherein the concierge service request includes a request for reserving a selected product or selected service for the user.

16. The method of claim 15 wherein the selected service includes a dining service.

17. The method of claim 15 wherein the selected service includes an entertainment.

18. The method of claim 15 wherein the selected service includes lodging.

19. The method of claim 15 wherein the selected information includes advertising information.

20. The method of claim 19 wherein the advertising information comports with the user's preferences.

21. The method of claim 20 wherein the user's preferences are maintained by the information assistance service.

22. The method of claim 11 wherein the selected information includes a suggestion of a product or service.

23. The method of claim 11 wherein the selected information includes an offer to reserve a product or service.

24. The method of claim 11 wherein the event is a selected one of a traffic condition, weather condition, and road condition.

25. The method of claim 11 wherein the communication from the user includes a telephone call.

26. The method of claim 11 wherein the second communication includes a telephone call.

27. A system for use by an information assistance service to assist a user, comprising:
an interface for receiving a communication from the user, the communication including a request for a service, a determination being made that a user is traveling to a destination based on the requested service;
a processor programmed to determine a location of the user when the user communicates with the information assistance service to track the user's progress to the destination;
a controller for monitoring for an event affecting the user's progress to the destination; and
a device responsive to a detection of an event affecting the user's progress to the destination for communicating, to the user, selected information to cope with a circumstance caused by the event.

28. The system of claim 27 wherein the service includes providing, to the user, directions to the destination.

29. The system of claim 28 wherein the user communicates with the information assistance service a plurality of times to obtain the directions in installments.

30. The system of claim 27 wherein the selected information includes advertising information.

31. The system of claim 30 wherein the advertising information comports with the user's preferences.

32. The system of claim 31 wherein the user's preferences are maintained by the information assistance service.

33. The system of claim 27 wherein the selected information includes a suggestion of a product or service.

34. The system of claim 27 wherein the selected information includes an offer to reserve a product or service.

35. The system of claim 27 wherein the event includes a selected one of a traffic condition, weather condition, and road condition.

36. The system of claim 27 wherein the communication includes a telephone call.

37. A system for use by an information assistance service to assist a user, comprising:
an interface for receiving a communication from the user using a communications device, the communication including a request for a concierge service, a determination being made that the user is traveling to a destination based on the concierge service request;
a processor programmed to locate the communication device when the user communicates with the information assistance service, thereby tracking the user's progress to the destination;
a controller for monitoring for an event affecting the user's progress to the destination; and
a communications unit responsive to a detection of an event affecting the user's progress to the destination for establishing a second communication to convey selected information to the user.

38. The system of claim 37 wherein the communications device is located using a wireless network triangulation technique.

39. The system of claim 37 wherein the communications device is located based on GPS information provided by the communications device.

40. The system of claim 37 wherein the communications device comprises a mobile telephone.

41. The system of claim 37 wherein the concierge service request includes a request for reserving a selected product or selected service for the user.

42. The system of claim 41 wherein the selected service includes a dining service.

43. The system of claim 41 wherein the selected service includes an entertainment.

44. The system of claim 41 wherein the selected service includes lodging.

45. The system of claim 41 wherein the selected information includes advertising information.

46. The system of claim 45 wherein the advertising information comports with the user's preferences.

47. The system of claim 46 wherein the user's preferences are maintained by the information assistance service.

48. The system of claim 37 wherein the selected information includes a suggestion of a product or service.

49. The system of claim 37 wherein the selected information includes an offer to reserve a product or service.

50. The system of claim 37 wherein the event is a selected one of a traffic condition, weather condition, and road condition.

51. The system of claim 37 wherein the communication from the user includes a telephone call.

52. The system of claim 37 wherein the second communication includes a telephone call.
